(19) United States
(12) Patent Application Publication
(10) Pub. No.: US 2026/0145918 A1
(43) Pub. Date: May 28, 2026

(54) ANTI-COLLISION DEVICE FOR CONSTRUCTION MACHINES AND METHOD FOR OPERATING SEVERAL CONSTRUCTION MACHINES

(71) Applicant: Liebherr-Werk Biberach GmbH, Biberach an der Riss (DE)

(72) Inventors: Robert BRAMBERGER, Rheinstetten (DE); Matthias MORATH, Biberach an der Riss (DE); Christian HÖRDEMANN, Biberach an der Riss (DE)

(73) Assignee: Liebherr-Werk Biberach GmbH, Biberach an der Riss (DE)

(21) Appl. No.: 19/178,643

(22) Filed: Apr. 14, 2025

Related U.S. Application Data
(63) Continuation of application No. PCT/EP2023/078178, filed on Oct. 11, 2023.

(30) Foreign Application Priority Data
Oct. 14, 2022 (DE) 10 2022 126 938.8

(51) Int. Cl. B66C 23/88; H04W 4/80

(52) U.S. Cl. CPC B66C 23/88; H04W 4/80

(57) ABSTRACT

The invention relates to a method for operating a plurality of construction machines, in particular in the form of cranes, the movements of which are monitored for imminent collisions by an anti-collision device, wherein ultra-wideband transmitting/receiving devices mounted on the plurality of construction machines exchange ultra-wideband signals, wherein the propagation times of the ultra-wideband signals between the construction machines are determined and imminent collisions are determined from the propagation times of the ultra-wideband signals.

### CROSS-REFERENCE TO RELATED APPLICATIONS

This application is a continuation of International Patent Application Number PCT/EP2023/078178 filed Oct. 11, 2023, which claims priority to German Patent Application Number DE 10 2022 126 938.8 filed Oct. 14, 2022, which are incorporated herein by reference in their entireties.

### BACKGROUND

The present invention relates to a method for operating a plurality of construction machines, in particular cranes, the movements of which are monitored for imminent collisions by an anti-collision device. The invention further also relates to an anti-collision device for monitoring and avoiding imminent collisions between two construction machines.

On construction sites, a plurality of construction machines is regularly used simultaneously, including often also a plurality of cranes, whose usually circular working areas partially overlap, which on the one hand may be due to the spatial conditions of the construction site, but on the other hand is also necessary in order to achieve the most complete possible coverage of the construction site area despite circular working areas. In order to prevent collisions between the cranes, in particular their jibs, in the area of partial overlapping of the working areas, the cranes are usually equipped with anti-collision devices that monitor crane movements and intervene in the crane controller in the working area at risk of collision, i.e. in said overlapping area, in order to slow down or stop movements or at least emit a warning signal if a collision is imminent.

Similar collision problems can also occur with other construction machines on the construction site, for example with a cable excavator, which typically swings back and forth in a circular sector with its jib and the excavator bucket roped to it and is also moved around the construction site from time to time to change the excavation site. Depending on the construction site, collisions with other construction machinery such as pipe layers, wheel loaders, bulldozers or the jibs of concrete pumps can also be a risk.

For this purpose, said anti-collision devices can use a suitable sensor system to determine the position or the movement of the crane itself, for example the alignment of the jib around the upright slewing axis using a rotary encoder on the slewing gear, the luffing position of the jib using a luffing sensor or the position of the trolley on the jib and thus the outreach of the hoist cable using a trolley sensor. By means of definable collision areas, the anti-collision device knows, by means of the crane position detected by sensors, when the crane is moving in said overlapping area, which carries the risk of a collision with another crane.

On the other hand, the anti-collision devices of the cranes or construction machines can also communicate with each other so that a respective anti-collision device knows whether the other crane or construction machine is also moving in the overlapping area or heading towards it. For this purpose, the anti-collision devices transmit in each case the position and/or status data of “their” construction machine determined by sensors or in another way to the anti-collision device of the “other” construction machines, so that the anti-collision device of a respective construction machine can take into account the position and/or status data of the other construction machines when deciding whether to intervene in the crane controller and influence a respective crane movement, in particular stop it, or at least emit a warning signal.

Such an anti-collision device is described, for example, in the patent document DE 24 41 785 A1, which, in order to detect the distances between the crane booms of several cranes, represents these distances between the crane booms as vectors and determines the distance between the boom tips or boom sections projected horizontally from the difference between the vectors.

From the patent document EP 18 94 882 B1 there is further also known an anti-collision device for cranes, which in itself determines movement vectors in a similar manner, but does not determine these as an actual value, but rather evaluates them in advance in order to be able to intervene early in movements that could cause a collision.

Setting up the anti-collision devices of such cranes and similar construction machinery has so far been relatively time-consuming and error-prone if the necessary care is not taken. Typically, in this case, by means of laser measuring devices, there is determined the distance between the cranes, more specifically the spacing of the crane centers, for example in the form of the tower tips of tower cranes. In this case, the alignment of the cranes to each other, in particular the alignment of the jibs to each other, must also be determined, which is usually done manually by manually bringing the cranes into a certain relative position and taking the corresponding values from the sensor system of the anti-collision system. Overall, this results in considerable installation effort, wherein safety-relevant errors can also occur if the measurements or manual alignment determination are not carried out carefully by an experienced person.

To simplify the calibration process, the patent document DE 10 2018 129 227 A1 proposes automatically providing the crane position and alignment to the anti-collision device using satellite navigation and an additional angle sensor system in order to avoid manual measurements as far as possible.

The patent document DE 10 2018 100 133 A1 also describes an anti-collision device for cranes which, in the event of an imminent collision, establishes a remote-control connection in order to “wake up” an out-of-service crane parked in the collision area from an active crane and move it out of the collision area.

Based on this, it is an underlying object of the present invention to create an improved anti-collision device, an improved method for operating a plurality of construction machines and an improved construction machine which avoids the disadvantages of the prior art and further develops the latter in an advantageous manner. In particular, there is to create an anti-collision device that is easy to set up and that can also be easily retrofitted to existing construction machinery, which reliably prevents or warns of imminent collisions and can also take into account machines that are only temporarily in the construction process.

### SUMMARY

According to the invention, said object is achieved by a method according to claim 1, an anti-collision device according to claim 11 and a construction machine according to claim 19. Preferred embodiments of the invention are the subject-matter of the dependent claims.

It is thus proposed to have the construction machines exchange ultra-wideband signals with each other and to determine imminent collisions from the propagation times of the ultra-wideband signals. According to the invention, ultra-wideband transmitting/receiving devices are mounted on a plurality of construction machines, wherein the ultra-wideband transmitting/receiving devices mounted on the plurality of construction machines exchange ultra-wideband signals, the propagation time of the ultra-wideband signals is measured and imminent collisions are determined from said propagation times.

By using the ultra-wideband transmitters and receivers, existing construction machines can be easily retrofitted without the need for time-consuming training of special anti-collision systems. From the propagation time of the ultra-wideband signals exchanged between the construction machines, the distance between the construction machines and a dangerous approach of the construction machines to each other can be determined, so that the anti-collision device can change a movement of at least one construction machine, in particular slow it down or stop it, or at least emit a warning signal to alert the machine operator to the imminent collision.

The ultra-wideband signals allow a plurality of construction machines, also of different types, to communicate with each other in a stable manner without reception interference impairing reliable collision detection. In addition, no special tuning measures are required to coordinate the machines with each other in order to operate the anti-collision device.

The ultra-wideband transmitting/receiving devices can use ultra-wideband signals in a large frequency range with a bandwidth of, for example, at least 500 MHz or at least 20% of the average of the lower and upper cut-off frequencies of the frequency band used. Advantageously, the ultra-wideband signals can also have a bandwidth of at least 25% or at least 30% of the center frequency. If the center frequency, i.e. the average value between the lower and upper cut-off frequency of the bandwidth, is 2 GHz, for example, the bandwidth may be 500 MHz or more.

In a further development of the invention, the ultra-wideband signals can in principle have a bandwidth of 100 MHz to 10 GHz or 500 MHz to 5 GHz or, for example, 800 MHz to 1.2 GHz.

The center frequency of the ultra-wideband signals can advantageously be selected in the range from 1 GHz to 20 GHz, for example 2 GHz to 10 GHz or between 3 GHz and 10 GHz.

Ultra-wideband signals of said bandwidth and center frequency ranges achieve stable communication and allow a reliable determination of propagation time.

In a further development of the invention, three ultra-wideband transmitting/receiving devices can be provided on each of the at least two construction machines, wherein the position and/or approach of the construction machines relative to each other can be determined by trilateration from the propagation times of the ultra-wideband signals.

Advantageously, said three ultra-wideband transmitting/receiving devices can be arranged in an at least approximately horizontal or lying plane in order to be able to determine approaches of relevant construction machine parts in a lying or horizontal direction. In particular, the three ultra-wideband transmitting/receiving devices can span a triangle that has a tip in the area of the boom tip of the crane and extends at least approximately parallel to the longitudinal axis of the boom and/or to a horizontal plane.

For example, if the construction machines are two or more than two cranes, two ultra-wideband transmitting/receiving devices can be mounted on the jib, for example on a boom tip and the articulation area of the jib on the tower or at the end of a counter jib, wherein a third ultra-wideband transmitting/receiving device can be arranged transversely offset from a connecting line through the two said ultra-wideband transmitting/receiving devices in the horizontal or horizontal direction. For example, a transverse jib or holder projecting transversely therefrom may be mounted on the jib or tower of the crane, which holds the third ultra-wideband transmitting/receiving device at the level of the two other transmitting/receiving devices and transversely spaced apart from said connecting line.

If necessary, the anti-collision device can also make use of the angle or alignment signal of an alignment sensor, which indicates the alignment of the respective construction machine. For example, in case of a crane, the rotational position signal of a slewing gear encoder or sensor can be taken into account, which indicates the rotational position of the slewing gear by means of which the crane can be rotated about an upright axis.

By means of said angle or orientation signal, the anti-collision device can determine in particular the direction in which the crane's jib is pointing or how the jib or another collision-relevant component of the construction machine is oriented relative to one or a plurality of other construction machines.

When using such an angle or alignment signal, it may be sufficient to attach only two ultra-wideband transmitting/receiving devices to the construction machine. The anti-collision device can determine the position of the construction machines relative to each other and/or their approach to each other by means of bilateration from the determined propagation times of the ultra-wideband signals, which in this case only two ultra-wideband transmitting/receiving devices per construction machine exchange with each other, wherein said angle and/or alignment signal can additionally be used to eliminate ambiguities in the position determination by bilateration or to clearly determine the positions and approaches.

Advantageously, the two said ultra-wideband transmitting/receiving devices can also be arranged in a horizontal or at least approximately horizontal plane on the respective construction machine if there are only two ultra-wideband transmitting/receiving devices. For example, if the construction machine is a crane, the two ultra-wideband transmitting/receiving devices can be mounted at opposite end portions of the jib of the crane.

In a further development of the invention, the evaluation of the ultra-wideband signals or the measured or otherwise determined propagation times of the exchanged ultra-wideband signals can be carried out by a respective anti-collision device on a respective construction machine, in particular on a respective crane, wherein the anti-collision device can, for example, be a module of the crane controller or the construction machine controller and can be implemented by means of a software module in a computer unit.

Alternatively or additionally, however, the anti-collision device can also have a central evaluation device to which the propagation times of the ultra-wideband signals exchanged between the ultra-wideband transmitting/receiving devices of the construction machines and/or the distances of the transmitting/receiving devices derived therefrom are also transmitted to a central evaluation device, which can, for example, be provided on a construction machine acting as a master or can also be part of a construction site control computer. Said central evaluation device can carry out a collision check and, as required, transmit a collision warning to the construction machinery concerned, whose machine control device can then react to the collision warning from the central evaluation device in a predetermined manner, for example by slowing down and/or modifying and/or stopping the approaching movement.

### BRIEF DESCRIPTION OF THE DRAWINGS

The invention will be explained in more detail in the following with respect to preferred embodiments and to associated drawings. The drawings show:

FIG. 1: shows a side view of two construction machines in the shape of tower cranes whose working areas overlap, wherein three ultra-wideband transmitting/receiving devices are provided on each crane;

FIG. 2: shows a plan view of the two cranes in FIG. 1, showing the arrangement of the ultra-wideband transmitting/receiving devices along the crane booms and on a transverse boom protruding therefrom, as well as the trilateration by means of ultra-wideband-based distance measurements;

FIG. 3: shows a side view of two cranes which have an overlapping working area and are each provided with only two ultra-wideband transmitting/receiving devices and an additional rotary position sensor system in order to determine collision-relevant approaches by means of bilateration using ultra-wideband transmitting/receiving device-based distance measurements and also with the aid of an alignment signal from the alignment sensor system; and

FIG. 4: shows a plan view of the two cranes in FIG. 3, which illustrates the arrangement of the two ultra-wideband transmitting/receiving devices along the jibs of the cranes and the resolution of the ambiguity of the position determination by means of the angle or direction of rotation signal.

### DETAILED DESCRIPTION

As the figures show, the anti-collision device 1 can monitor a plurality of construction machines, for example in the form of cranes 2, 3, and protect them from collisions, wherein said cranes 2, 3 can be configured, for example, in the form of tower cranes, each comprising a jib 4 which can be arranged horizontally and supported on a tower 5. However, the cranes 2, 3 can also be configured in the form of other types of crane, such as a collapsible fast-erecting crane or a telescopic boom crane.

In a manner known per se, the two cranes 2, 3 can each be rotated about an upright axis by means of a slewing gear 5, so that their jibs 4 can each sweep over a circular or ring-shaped working area, wherein said working areas of the cranes 2, 3 can overlap in a collision area, cf. FIG. 2 and FIG. 4. Even if the jibs 4 can be arranged at different heights, a corresponding collision area can result from the hoist cables running off the jibs 4, which carry the load hook and can descend, for example, from a trolley 6, which can be movable along the respective jib 4.

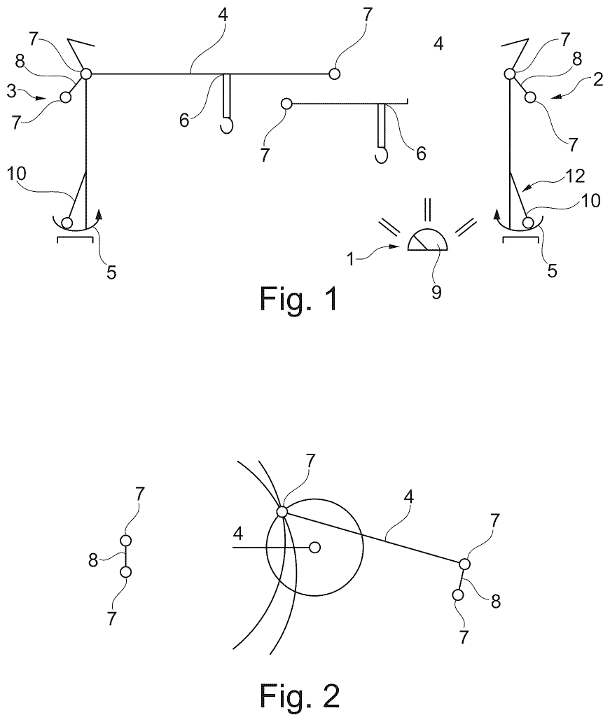

As shown in FIGS. 1 and 2, the anti-collision device 1 on each crane 2, 3 may comprise a plurality of ultra-wideband transmitting/receiving devices and ultra-wideband receiving devices. Said ultra-wideband transmitting and ultra-wideband receiving devices may be configured and arranged separately from each other, wherein this is not mandatory. Said ultra-wideband transmitting/receiving devices may also be combined to form an ultra-wideband module or component, for example integrated in a common operative structure with an ultra-wideband antenna device, wherein said antenna unit may, for example, periodically switch from transmit mode to receive mode and back.

As FIGS. 1 and 2 show, the ultra-wideband transmitting/receiving devices 7 are arranged distributed on the jibs 4, for example in the area of a boom tip and in the area of a jib articulation on the tower. In addition to two ultra-wideband transmitting/receiving devices 7 mounted at a distance apart on the jib 4, at least one further ultra-wideband transmitting/receiving device 7 is arranged on each of the cranes 2, 3, which can be arranged at the same height as the two other transmitting/receiving devices 7 and can be arranged at a distance transversely from a connecting line between the two aforementioned transmitting/receiving devices 7 on the jib 4, for example by means of a transverse jib 8, which can be mounted, for example, on the tower or on the jib 4 itself and protrudes transversely therefrom. Regardless of the actual fastening or mounting, it can be advantageous if the three ultra-wideband transmitting/receiving devices 7 of each crane 2, 3 are arranged in a horizontal plane and/or span a triangle, cf. FIGS. 1 and 2.

The ultra-wideband transmitting/receiving devices 7 communicate with each other and exchange ultra-wideband signals, so that the propagation times of the ultra-wideband signals can be used to determine the distances of the transmitting/receiving devices 7 and thus the spacing of the cranes 2, 3 and in particular the spacing of their jibs 4 from each other.

In this case, the ultra-wideband transmitting/receiving devices 7 arranged on the same crane 2 or 3 can also communicate with each other, so that the propagation times can serve as reference values reflecting the known distances of the transmitting/receiving devices 7 on the same crane.

From the ultra-wideband signals exchanged between the cranes 2, 3 and their propagation times, the anti-collision device 1 can determine the position of the cranes 2, 3 and in particular the position of their jibs 4 relative to each other. In particular, the anti-collision device 1 can also determine approaches of the cranes 2, 3, in particular the jibs 4, towards each other or generally relative movements between the relevant components of the cranes 2, 3.

The anti-collision device 1 can comprise a central computer 9, which can be provided, for example, on one of the cranes acting as a master in this case, for example integrated into its crane controller. Alternatively or additionally, however, a central computer 9 separate from the cranes 2, 3 or the construction machines can also be used, to which the propagation times or the distances between the ultra-wideband transmitting/receiving devices 7 or the cranes 2, 3 or the jibs 4 determined therefrom can be transmitted, so that the separate central computer 9, which can be integrated into or connected to for example a construction site control computer, can determine machine movements that pose a risk of collision and transmit a corresponding warning signal to the construction machines or the cranes 2, 3.

The anti-collision device 1, in particular its central computer 9, can be configured to determine the relative positions of the cranes 2, 3, in particular of their jibs 4, or of the ultra-wideband transmitting/receiving devices 7 mounted thereon, by means of trilateration based on the propagation times and, by means of the changes in the relative positions, to determine approaches that are at risk of collision.

As FIG. 2 shows, trilateration can be carried out by means of the ultra-wideband transmitting/receiving device 7 projecting transversely from the jib 4 or mounted to the side of the tower, wherein the circles shown in FIG. 2 represent ultra-wideband-based distance measurements. The position of the ultra-wideband transmitting/receiving device 7 in the area of the boom tip of the other crane can be clearly determined by the two rear ultra-wideband transmitting/receiving devices 7 mounted in the area of the boom pivot point and spaced apart from one another transversely.

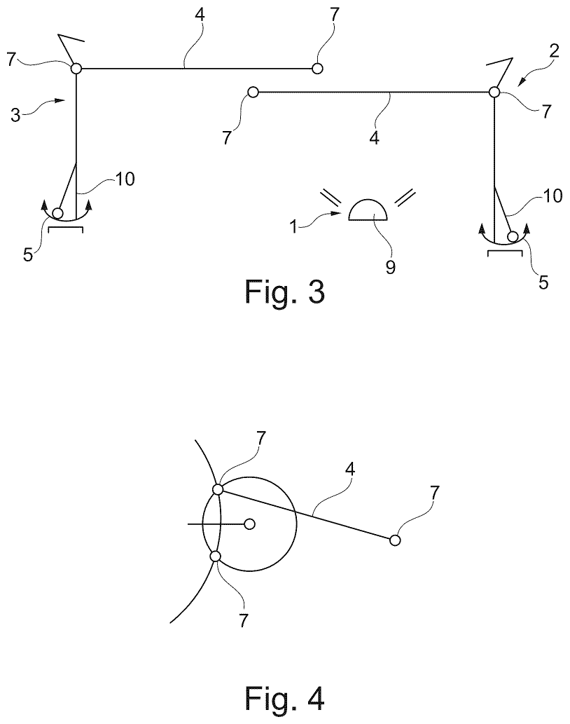

As FIGS. 3 and 4 show, it may also be sufficient to mount only two ultra-wideband transmitting/receiving devices 7 on each of the two cranes 2, 3 or the corresponding construction machines, wherein in the case of cranes 2, 3 the transmitting/receiving devices 7 can be mounted, for example, in the area of the boom tip and in the area of the articulation point of the boom 4, see FIG. 3.

However, with only two ultra-wideband transmitting/receiving devices 7, the relative position of the ultra-wideband transmitting/receiving device 7 mounted in the area of the boom tip of the other crane can only be determined ambiguously. An ambiguity arises in that the boom tip of the other crane 3 can be to the right or left of the jib 4 of the first crane 2, cf. FIG. 4, and still have the same distance from each of the two ultra-wideband transmitting/receiving devices 7 of said first crane 2.

In order to resolve this ambiguity, the anti-collision device 1 may rely on an angular or alignment signal indicating the angular position or alignment of the two cranes 2, 3 with respect to each other. For example, the anti-collision device 1 may take into account two angular signals that indicate the rotational position of the two cranes 2, 3 and thus characterize the relative angular position of the two cranes 2, 3 relative to each other.

Said angular signals can, for example, come from decoders or sensor systems that indicate the rotational position of the two cranes respectively.

We claim:

1. A method for operating a plurality of construction machines, the method comprising:
monitoring the movements of cranes for an imminent collision by an anti-collision device wherein ultra-wideband transmitting/receiving devices mounted on the plurality of construction machines exchange ultra-wideband signals, wherein the propagation times of the ultra-wideband signals between the construction machines are determined and imminent collisions are determined from the propagation times of the ultra-wideband signals.

2. The method of claim 1, wherein the ultra-wideband signals having a bandwidth of more than 20% or more than 25% or more than 35% of the central frequency are exchanged.

3. The method of claim 1, wherein the ultra-wideband signals having a bandwidth of more than 500 MHz or more than 1 GHz are exchanged.

4. The method of claim 1, wherein the ultra-wideband signals having a central frequency in the range of 500 MHz to 10 GHz or 1 GHz to 10 GHz or 3 GHz to 8 GHz are exchanged.

5. The method of claim 1, further comprising emitting a warning signal by the anti-collision device in the event of the imminent collision and/or the control of at least one of the construction machines is intervened in the movements thereof, wherein the intervention of the movements thereof comprises changing and/or braking and/or stopping the movement.

6. The method of claim 1, wherein each construction machine comprises at least three ultra-wideband transmitting/receiving devices, and further comprising determining the positions and/or approaches of the construction machines relative to each other by trilateration on the basis of the propagation times of the ultra-wideband signals exchanged between the ultra-wideband transmitting/receiving devices.

7. The method of claim 6, wherein a triangle is spanned by the three ultra-wideband transmitting/receiving devices in a horizontal plane, and wherein the triangle has a tip in a region of a boom tip.

8. The method of claim 1, wherein each construction machine comprises two ultra-wideband transmitting/receiving devices, and further comprising determining the position and/or approach of the construction machines relative to each other by bilateration on the basis of the propagation times of the ultra-wideband signals exchanged and by an alignment signal characterizing the angular alignment of two of the construction machines relative to each other.

9. The method of claim 8, further comprising determining the angular alignment of the two of the construction machines relative to each other by a slewing gear sensor system, wherein the slewing gear sensor system determines the rotational positions of the construction machines about upright rotational axes.

10. The method of claim 1, further comprising determining the propagation times of the ultra-wideband signals by propagation time determination devices on the construction machines, transmitting the determined propagation times and/or distances of the construction machines derived therefrom to a common, central evaluation device, determining by the common, central evaluation device imminent collisions by the transmitted propagation times and/or distances and collision warning signals, and transmitting the imminent collisions to the construction machines of concern.

11. An anti-collision device for monitoring and avoiding imminent collisions between two construction machines comprising cranes, the device comprising:
a plurality of ultra-wideband transmitting/receiving devices on each of the construction machines for exchanging ultra-wideband signals,
a propagation time determination device for determining the propagation times of the ultra-wideband signals exchanged between the construction machines, and
a position and/or proximity determination device for determining the position of the construction machines relative to each other and/or the proximity of the construction machines to each other by the determined propagation times of the ultra-wideband signals.

12. The anti-collision device of claim 11, further comprising at least three ultra-wideband transmitting/receiving devices on each construction machine, and wherein the position and/or proximity determining device is configured to determine the position and/or proximity of the construction machines by trilateration on the basis of the propagation times of the ultra-wideband signals.

13. The anti-collision device of claim 12, wherein the at least three ultra-wideband transmitting/receiving devices span a triangle in a horizontal plane.

14. The anti-collision device of claim 13, wherein two ultra-wideband transmitting/receiving devices are in the region of a jib of the construction machine, and a further ultra-wideband transmitting/receiving device is at a distance transversely from the jib.

15. The anti-collision device of claim 14, wherein an ultra-wideband transmitting/receiving device is mounted in the region of a boom tip, a further ultra-wideband transmitting/receiving device is mounted in the region of an articulation of the jib, and a further ultra-wideband transmitting/receiving device is mounted on a transverse jib protruding transversely relative to the jib.

16. The anti-collision device of claim 11, wherein only two ultra-wideband transmitting/receiving devices on each construction machine, and further comprising an angular alignment determination device for determining the angular alignment of the construction machines relative to each other, wherein the position and/or approach determination device is configured to determine the position and/or approach of the construction machines relative to each other by bilateration on the basis of the propagation times of the exchanged ultra-wideband signals and by the determined angular alignment of the construction machines relative to each other.

17. The anti-collision device of claim 16, wherein the angular alignment determining device comprises rotation angle sensors for determining the rotation angles of slewing gears of the construction machines.

18. The anti-collision device of claim 11, further comprising a central evaluation device for evaluating the propagation times of the ultra-wideband signals, wherein the a central evaluation device is on one of the construction machines or separate from all construction machines.

19. A construction machine comprising a crane, comprising:
an anti-collision device for monitoring and avoiding imminent collisions with another construction machine, wherein the anti-collision device has a plurality of ultra-wideband transmitting/receiving devices spaced apart from one another, and wherein the a plurality of ultra-wideband transmitting/receiving devices are configured to exchange ultra-wideband signals with ultra-wideband transmitting/receiving devices on another construction machine.

20. The construction machine of claim 19, wherein the anti-collision device comprises a propagation time determining device for determining the propagation times of the ultra-wideband signals exchanged with the the another construction machine, and a position determining device for determining the position relative to the other construction machine on the basis of the propagation times of the ultra-wideband signals.
